(19) United States
(12) Patent Application Publication
(10) Pub. No.: US 2011/0264560 A1
(43) Pub. Date: Oct. 27, 2011

(54) IN-PRODUCT NAVIGATION SYSTEM AND METHOD

(75) Inventors: Andrew John Griffiths, Santa Rosa, CA (US); Daniel Peter Barbata, Santa Rosa, CA (US); Dina Romanovna Luvishis, Santa Rosa, CA (US); Kandice Renee Haas, Santa Rosa, CA (US)

(73) Assignee: Andrew John Griffiths, Santa Rosa, CA (US)

(21) Appl. No.: 13/091,639

(22) Filed: Apr. 21, 2011

Related U.S. Application Data
(60) Provisional application No. 61/326,396, filed on Apr. 21, 2010.

(51) Int. Cl. G06Q 30/00

(52) U.S. Cl. 705/27.1

(57) ABSTRACT

A system for configuring a web page to display a product list is provided. A storage module stores product information that includes product attributes associated with products. A web page generation module is in signal communication with the storage module and receives the product attributes from the storage module. The web page generation module constructs a web page that includes a product list that lists products stored in the storage module. The web page generation module encodes the product attributes as a selectable portion of a product identifier for the products. The web page generation module includes the selectable portion of the product identifier that corresponds to the encoded product attribute in the product list of the web page such that the product attribute is selectable from the product list when the product list is displayed on the web page.

### CROSS-REFERENCE TO RELATED APPLICATION

This application claims the priority of U.S. Provisional Application Ser. No. 61/326,396 titled IN-PRODUCT NAVIGATION SYSTEM AND METHOD, filed on Apr. 21, 2010, which is incorporated by reference in its entirety in this application.

### FIELD OF THE INVENTION

This invention relates to online systems for browsing consumer product lists and in particular to systems and methods for filtering lists of consumer products.

### BACKGROUND

The proliferation of the Internet has changed the way in which consumers shop for retail products. Information technology innovations have resulted in new ways in which products are presented online to consumers as well as new ways in which consumers search for products online. Further, computing technology has improved the categorization and organization of retail products, which has provided consumers with new ways to browse online product lists.

One example of a conventional method of product navigation method is referred to as faceted navigation. This style of product navigation aggregates the searchable characteristics of the products in a product list and displays the collected characteristics to the user near the product list. For example, a website using faceted navigation may display the list of searchable product characteristics in a side bar next to the product list or in horizontal displays above the product listing. Examples of searchable characteristics may include: brand name, size, color, and other features related to the products. A consumer may select a characteristic in the horizontal display or side bar to search for products having the selected characteristic.

However, product navigation using the faceted navigation approach has limitations. Consumers are often concerned about the user-experience when browsing products lists online and judge websites by how fast and easy it is to search for and locate products. If consumers have difficulty navigating, searching, or sorting product lists, they may give up and leave the website before they locate the desired product. Faceted navigation approaches may diminish the user experience by positioning the horizontal or side bar at fixed locations near the product list (e.g., above the product list or to the side of the product list). Positioning the searchable characteristics at a fixed location may be ill-suited for extensive product lists, in which the consumer may be required to continuously scroll back and forth between the characteristics and the current position of the product list. This style of product navigation may take additional time and may require additional mouse movement, thus diminishing the user experience.

Further, the amount of screen real estate may limit the number of searchable characteristics that may be displayed in the horizontal or side bars. As a result, faceted product navigation may not be best suited for product lists having a large number of searchable characteristics. Moreover, consumers may become frustrated if they must spend additional time browsing the horizontal and side bars for a desired characteristic. Accordingly, faceted product navigation may not be the best option where speed and ease-of-use are a primary concern.

To address the limitations of conventional faceted product navigation, a new approach to product navigation and product filtering has been developed. This new style of product navigation and filtering is referred to as in-product navigation.

### SUMMARY

A computer-implemented method for updating a product list displayed on a web page is provided. A request to update the product list is received. The request contains an update criterion associated with a selectable portion of a product identifier of a product displayed in the product list of the web page. A product list that corresponds to the product list in the web page is updated based on the update criterion. The updated product list is then transmitted in a response such that the updated product list replaces the product list of the web page.

A computer-implemented method of configuring a web page to display a product list is also provided. Product attributes associated with a product are received. The received product attributes are encoded as selectable portions of a product identifier for the product. The selectable portions of the product identifier that correspond to the encoded product attributes are included in the product list of the web page. When the product list is displayed on the web page, the product attribute is selectable.

A system for updating a product list displayed on a web page is additionally provided. A request processing module receives a request to update the product list. The request contains an update criterion that is associated with a selectable portion of a product identifier of a product in the product list displayed in the web page. The request processing module updates a product list that corresponds to the product list of the web page based on the update criterion. The request processing module transmits the updated product list in a response such that the updated product list replaces the product list of the web page.

A system for configuring a web page to display a product list is further provided. A storage module stores product information that includes product attributes associated with products. A web page generation module is in signal communication with the storage module and receives the product attributes from the storage module. The web page generation module constructs a web page that includes a product list that lists products stored in the storage module. The web page generation module encodes the product attributes as a selectable portion of a product identifier for the products. The web page generation module includes the selectable portion of the product identifier that corresponds to the encoded product attribute in the product list of the web page such that the product attribute is selectable from the product list when the product list is displayed on the web page.

### BRIEF DESCRIPTION OF THE DRAWINGS

FIG. 1 is a block diagram of an example of an implementation of an in-product navigation system.

FIG. 2 is a flowchart of an example of an implementation of an in-product navigation method.

FIG. 3 is a flowchart of an example of an implementation of a preprocessing process of an in-product navigation method.

FIG. 4 is a flowchart of an example of an implementation of a client request processing process of an example in-product navigation method.

FIG. 5 is a flowchart of an example of an implementation of a page construction process of an example in-product navigation method.

FIG. 6 is a flowchart of an example of an implementation of an attribute encoding process for product names and description of an example in-product navigation method.

FIG. 7 is a flowchart of an example of an implementation of a filter request processing process of an example in-product navigation method.

FIG. 8 is an example of an implementation of a web page configured for in-product navigation that includes a product listing.

FIG. 9 is the example implementation of the web page of FIG. 8 that includes a filtered product listing.

FIG. 10 is the example implementation of the web page of FIG. 9 that includes a further filtered product listing.

### DETAILED DESCRIPTION

A system and method for in-product navigation are described herein. In-product navigation improves the task of searching and filtering product lists of web pages. The in-product navigation system and method described in this application parses product information and builds attribute lists for each product. The product information may include the name of the product and various product characteristics. Product names and characteristics may be used as the product attributes associated with products. The in-product navigation system and method encodes and formats the individual product attributes as discrete selectable elements. The in-product navigation system and method then constructs a product identifier composed of the selectable product attributes. Accordingly, the portions of the product identifier may include a selectable product name and selectable product characteristics. The in-product navigation system and method then includes the product identifier with the selectable product names and descriptions in the product listing of the web page. As a result, users may update (e.g., filter) the list of products directly from the product listing on the web page by selecting one or more of the selectable product attributes in the product identifier. The product identifier may be the product text descriptions that make up a product list, brought to view by a web query or navigation through a category structure in an e-commerce environment. In some example implementations, the product identifier may also be referred to as the name, product, product title, title, product description, and description.

The various components and steps of the respective system and method will be described in further detail below. The various components and modules described below may be implemented as one or more computer applications on one or more computing or digitally-controlled devices. The computing devices may include components common to computing devices, which may be omitted from the figures discussed below. These conventional components include processing devices, storage modules and storage devices, and I/O ports, etc. The devices, components, and modules may be in signal communication with (i.e., coupled to) one another.

The term “in signal communication” as used in the application means that two or more devices and/or components are capable of communicating with each other via signals that travel over some type of signal path. The signals may be communication, power, data, or energy signals which may communicate information, power, and/or energy from a first device and/or component to a second device and/or component along a signal path between the first device and/or component and second device and/or component. The signal paths may include physical, electrical, magnetic, electromagnetic, optical, electrochemical, wired, and/or wireless connections between the first device and/or component and second device and/or component. The signal paths may also include additional devices and/or components between the first device and/or component and second device and/or component. As used in this application, “in signal communication with” may be used interchangeably with “coupled to.”

The computer applications may be implemented as one or more software or firmware programs using one or a combination of programming languages suitable for carrying out the functions described below. The computer applications include instructions for carrying out the functions described below. The instructions are capable of being executed by a processing device. Examples of suitable programming and computer languages that may be used to implement the various functions of the system and method described include: Java, PHP, SQL, XML, Perl, C, C++, C#, Ruby, and other suitable programming languages.

The processing devices may be any form of microprocessor capable of executing instructions or code. The storage modules and storage devices may be any form of volatile or non-volatile data storage mechanisms including, for example, magnetic media, optical disks, random access memory (RAM), flash memory, electrically erasable programmable read-only memory (EEPROM), and the like.

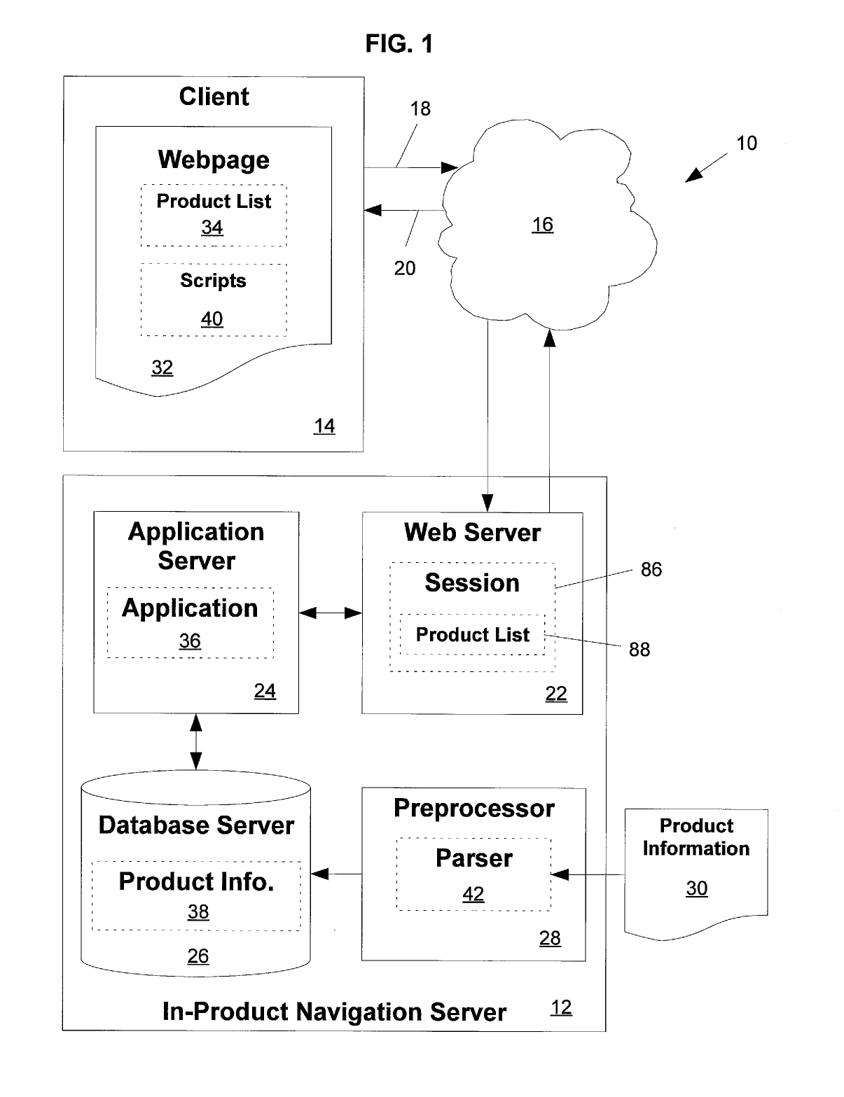

Referring to FIG. 1, a block diagram of an example of an implementation of an in-product navigation system 10 is shown. As seen in FIG. 1, the in-product navigation system 10 has a server/client-based architecture. An in-product navigation server 12 is in signal communication with one or more clients 14 via a data network 16. The client 14 is a network-enabled device adapted to wiredly or wirelessly communicate with the in-product navigation server 12 via the network 16. Accordingly, the client 14 may submit a request 18 to the in-product navigation server 12 and receive a response 20 in return. Clients 14 may include, for example, desktop computers, laptop computers, tablet computers, cellular telephones, vehicle navigation or entertainment devices, video game consoles, televisions, television set-top boxes, and other network-enabled computer or digitally-controlled devices.

The in-product navigation server 12 is in signal communication with the clients 14 via a network 16 using one or a combination of wired and wireless technologies. For example, the in-product navigation server 12 may communicate with the clients 14 using TCP/IP and HTTP via a packet-switched network 16 (e.g., the Internet). The in-product navigation server 12 may additionally or alternatively communicate with the clients 14 via a cellular network or other wireless network. Other types of networks and networking protocols may be selectively employed.

As the in-product navigation server 12 is adapted to receive and process requests from clients, the in-product navigation server may also be referred to as a request processing module. The in-product navigation server 12 may be a cluster of one or more servers configured to carry out the functions of the in-product navigation system 10 and method. The in-product navigation server 12 may include a web server 22, an application server 24, and a database server 26. The in-product navigation server 12 may also include a preprocessor 28 for preprocessing product names and descriptions 30. The components of the in-product navigation server 12 may be selectively implemented as one or more modules of a single server or, alternatively, as a cluster of distributed servers having one or more modules and interconnected by a data network such as, for example, a local area network (LAN). Other configurations for the in-product navigation server 12 may be selectively employed as well.

The web server 22 is the interface between the in-product navigation server 12 and a client 14. The web server 22 receives requests 18 from the client via the network 16 (e.g., the Internet) and transmits responses 20 to the client. The requests 18 and responses 20 may be, for example, HTTP requests and HTTP responses respectively. The web server 22 is in signal communication with the application server 24 in order to process client requests 18. Further, a client request 18 may be, for example, a request for a web page 32, a request for an updated (filtered) product listing 34, or a request for other information related to a product, the product list, or in-product navigation as discussed further below.

The application server 24 includes an in-product navigation application 32 for processing client requests 18. As the application is adapted to generate web pages in response to client requests, the application may also be referred to as a web page generation module. The in-product navigation application 36 includes, for example, instructions for building web pages 32 containing the list of products 34 and for filtering the product list. The in-product navigation application 36 may be implemented as one or more software or firmware programs or modules containing instructions adapted for execution by a processor (not shown) of the in-product navigation server 12. The application server 24 is in signal communication with the database server 26 to retrieve stored product names and descriptions 38. The application server may retrieve the stored product names and descriptions 38 from the database server 26 when building web pages 32 and filtering product lists 34. As seen in FIG. 1, the web page 32 built by the in-product application 36 and transmitted to the client 14 may include a product listing 34 and various scripts 40 as explained further below.

The database server 26 is the storage location for the stored product names, descriptions, and attributes (i.e., product information) 38. The database server 26 may be implemented according to the relational database model. Accordingly, the database server 26 may include one or more databases having one or more tables for storing the product information. Additionally, the databases of the database server may be implemented and managed with an MS SQL database management system. Additional or alternative database models (e.g., a flat-file database model, an object-oriented database model, etc.) and database management systems (e.g., MySQL, Oracle, etc.) may be selectively employed. The database server 26 may also be in signal communication with a preprocessor 28 of the in-product navigation server 12 and received parsed product information from the preprocessor.

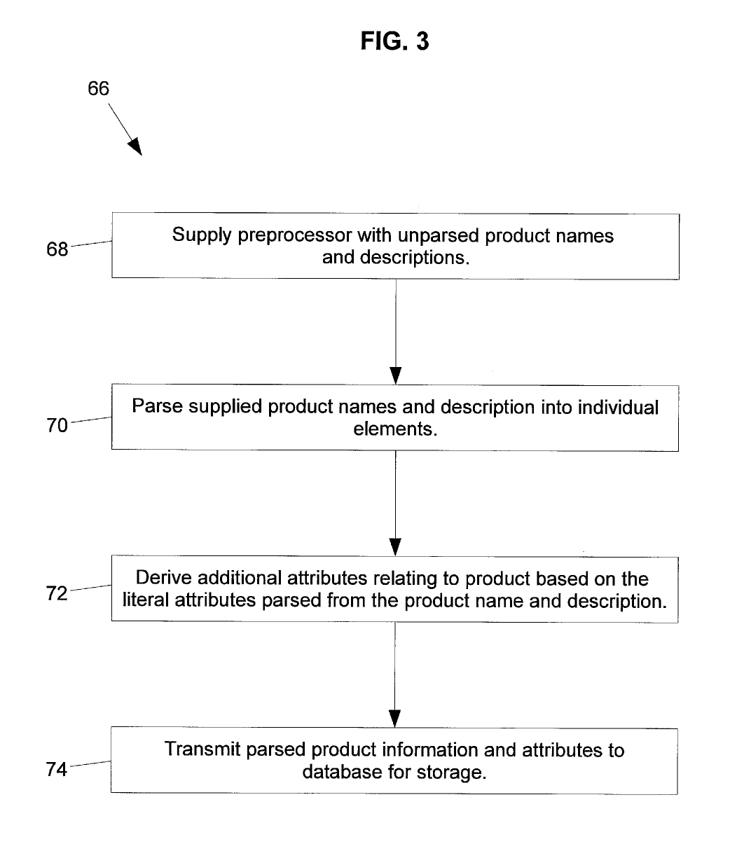

The in-product navigation server 12 may also include a preprocessor 28 for parsing product information 30 in order to build product attribute lists based on the product names and descriptions. Accordingly, the preprocessor 30 may include a parser 42 for parsing and processing the product names and descriptions 30. The preprocessor 30 may store the parsed product information (i.e., product names, descriptions, and attributes) in the databases of the database server 26. As discussed further below with reference to FIG. 3, the individual words or phrases of the product name and product description may be extracted and stored as attributes related to the product.

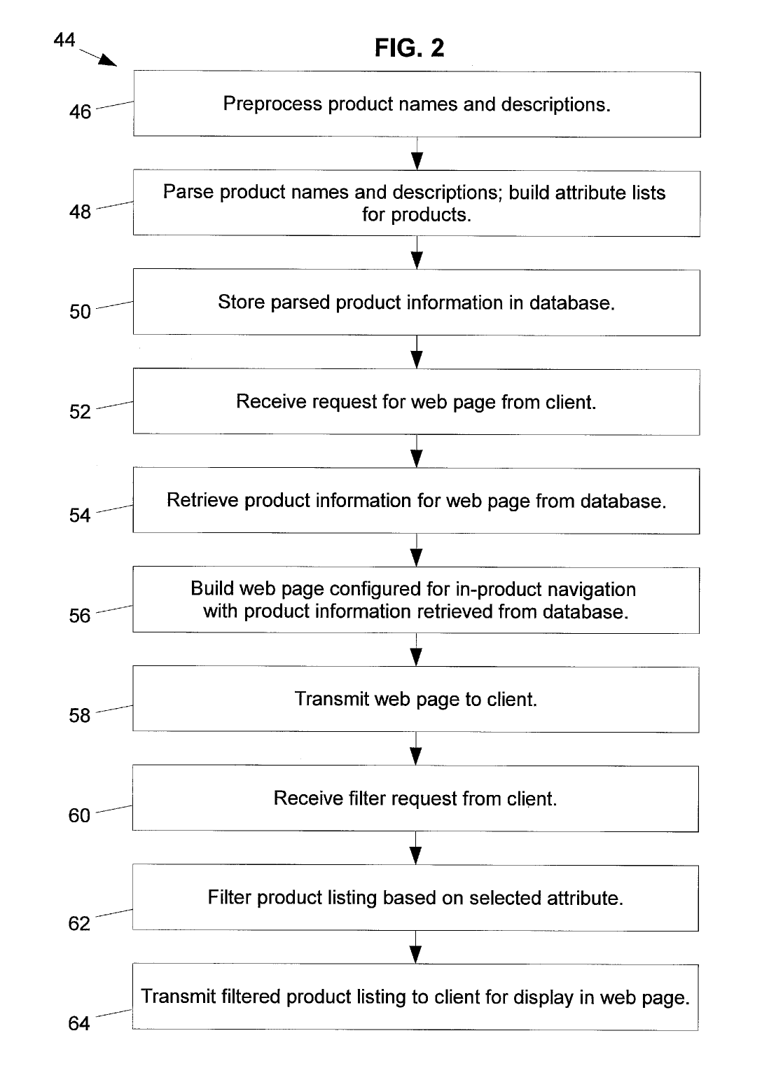

Referring now to FIG. 2, a flowchart of an example of an implementation of an in-product navigation method 44 is shown. The method for in-product navigation 44 may begin when the product names and descriptions (step 46) are preprocessed. During preprocessing, the preprocessor 28 parses the product names and descriptions 30 and builds attribute lists for the products (step 48). Preprocessing will be discussed in further detail below with reference to FIG. 3.

Once the preprocessor 28 has parsed the product names and descriptions 30 and has built the attribute lists, the preprocessor sends the product information to the database server 26 for storage (step 50). The storage of product information 38 at the database server 26 will also be discussed further below with reference to FIG. 3.

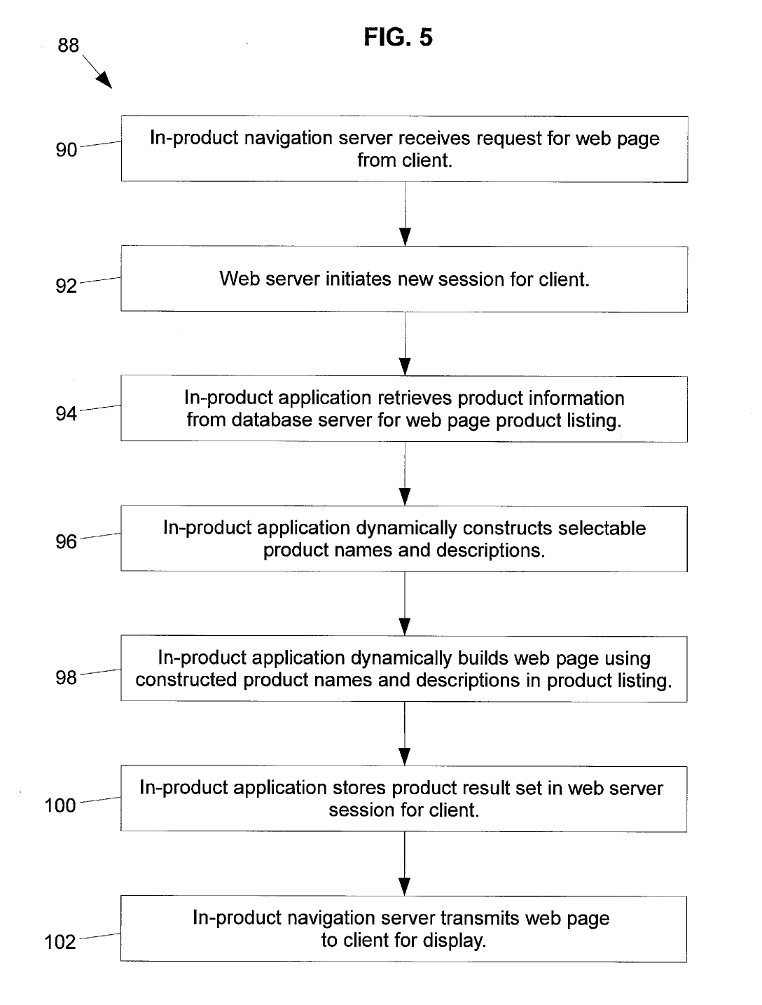

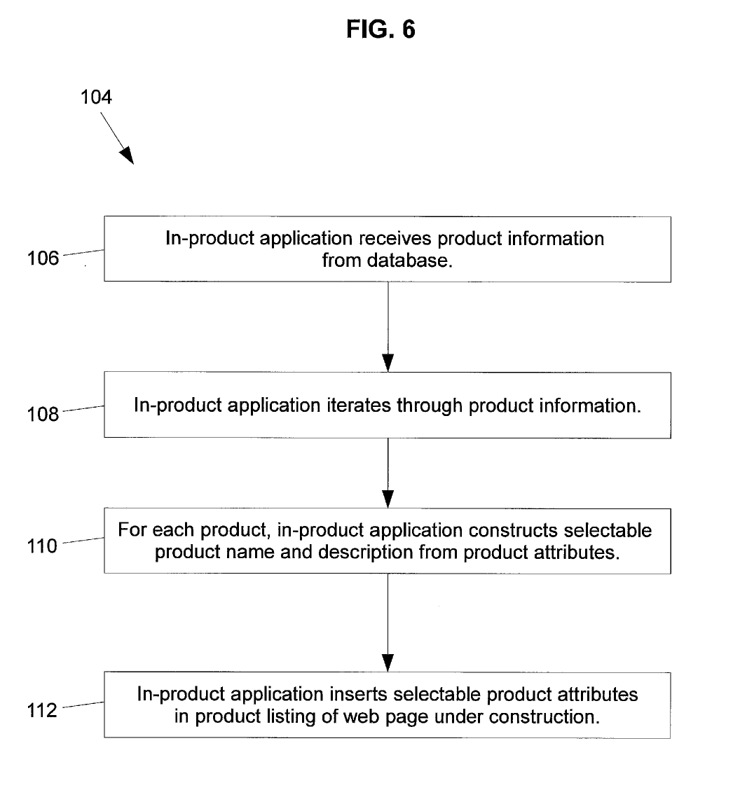

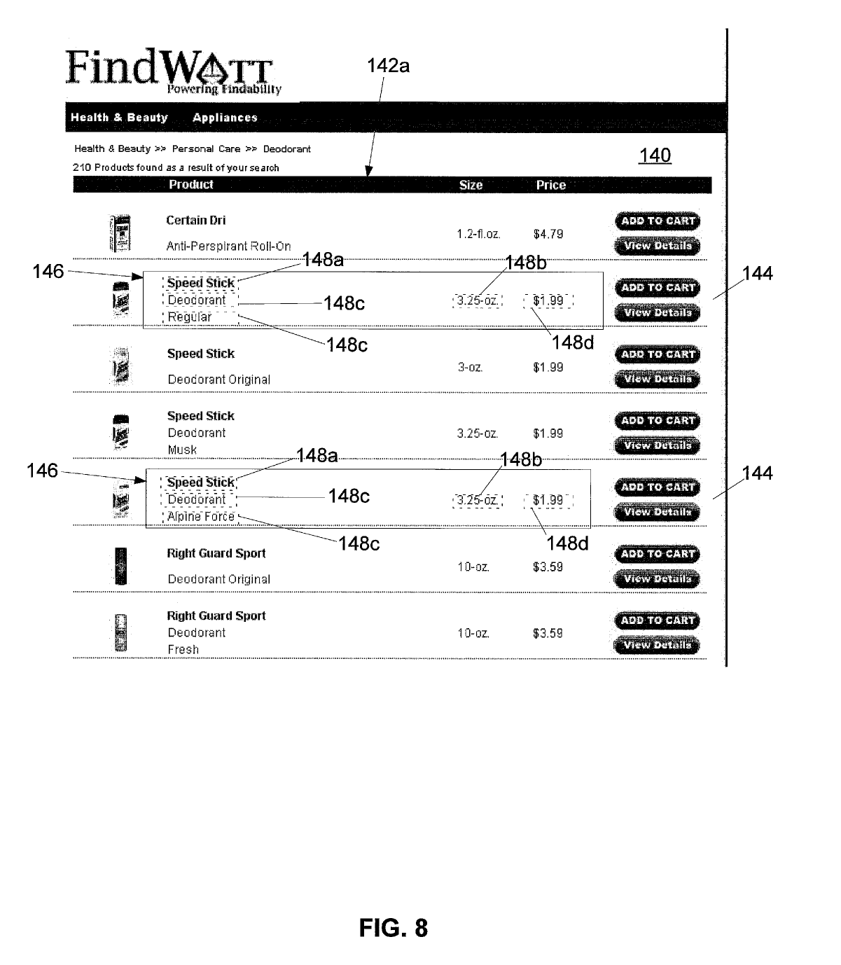

Once the one or more databases at the database server 26 have been populated with the product information and attributes 38, clients 14 may use the in-product server 12 for in-product navigation. The client 14 may submit a request 18 for a web page 32 that includes a product listing 34. The in-product navigation server 12 receives the web page request 18 and retrieves from the database server 26 the appropriate product information 38 for the requested web page 22 (step 52). The in-product application 36 then dynamically builds a web page 32 that includes a product listing 34 comprised of the product information 38 retrieved from the database server 26. As the in-product application 36 dynamically builds the web page 32 the in-product application configures the web page for in-product navigation. In particular, the in-product application 36 retrieves the product information for the web page from the database (step 54) and encodes the product attributes as selectable elements. The In-product application then constructs a product identifier (e.g., a product name and product characteristics) from the encoded attributes such that the individual portions of the product identifier are selectable elements (FIG. 8) for filtering the product listing 34 (step 56). Additionally, the in-product application 36 may include with the web page 32 various scripts 40 used to filter the product listing 34 displayed at the client 14. The web server 22 of the in-product navigation server 12 then transmits the generated web page 32 to the client 14 in a response 20 (step 58). The web page construction process and the attribute encoding process will be discussed below in more detail with reference to FIG. 5 and FIG. 6 respectively.

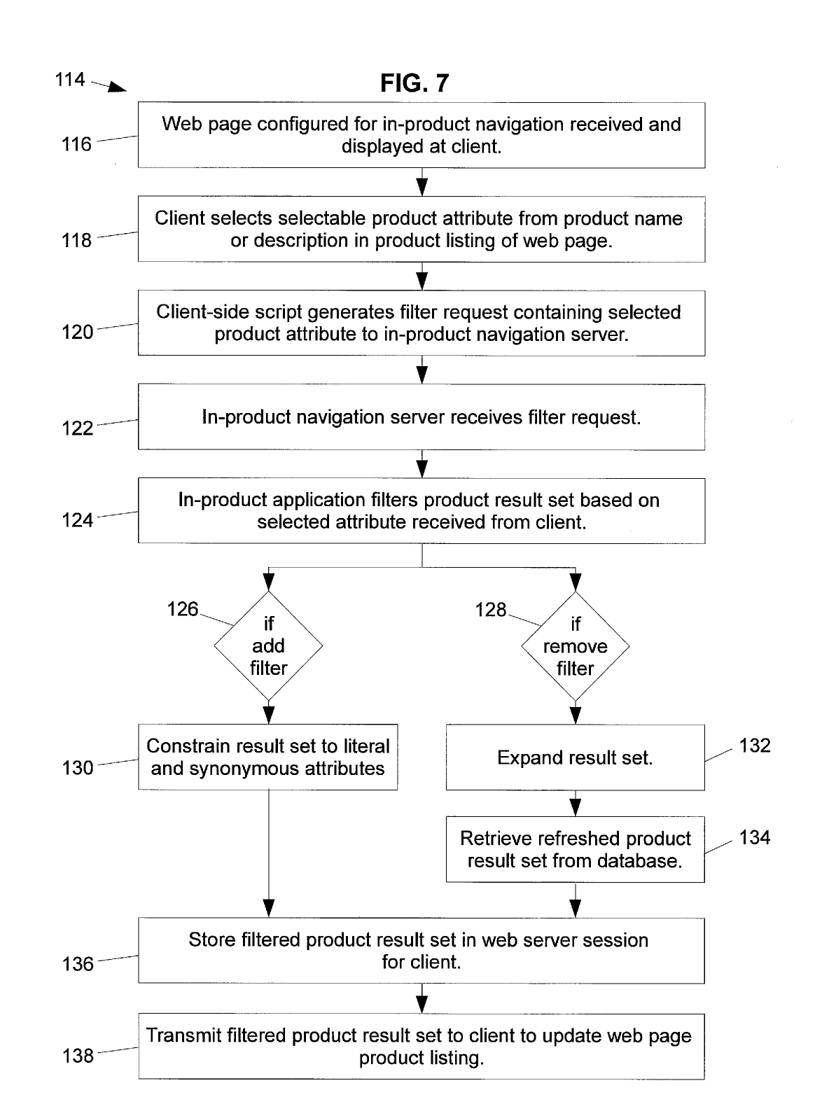

The client 14 may display the received web page 32 in, for example, a web browser on a display device and browse the products in the product listing 34. A user at the client 14 may select an attribute in order to filter the product listing 34. A client-side script 40 may generate a request 18 to filter the product listing that contains the selected attribute and may transmit the request to filter the product list to the in-product navigation server. The selected attribute may be the criterion used to update and filter the product listing at the in-product navigation server 12. The in-product server 12 receives the filter request from the client (step 62), and the in-product application 36 may filter the product listing based on the selected attribute (i.e., update criterion) (step 62). The web server then transmits the filtered product listing to the client in a response 20 (step 64), and the product listing 34 displayed on the web page 32 at the client 14 is updated to display the filtered product listing received from the in-product navigation server 12. The client 14 may transmit subsequent filter requests 18 to further narrow or expand the product listing 34 displayed in the web page 32. The filtering process will be discussed in further detail below with reference to FIG. 7.

Referring now to FIG. 3, a flowchart of an example of an implementation of a preprocessing process 66 of an in-product navigation method 44 is shown. The preprocessor receives a data document that includes compiled product information (e.g., product names, product descriptions, product attributes, etc.) The data document may be for example, a CSV (comma-separated values) document, an XML document, or an XLS (Microsoft Excel) document. The preprocessing process 66 parses the product information 30, builds attribute lists for the products, and populates one or more databases of the database server 26 with the parsed product information. First, the preprocessor received the compiled product information 30 (step 68). An administrator may supply the preprocessor 28 with the compiled product information 30 via an administration interface (not shown) of the in-product navigation server 12.

The preprocessor 28 then parses (i.e., extracts) the product information 30 from the compiled product data and identifies product names, descriptions, and attributes (step 70). Each word or phrase parsed from the product information may represent an attribute that can be associated with the product. Additionally, the words and phrases parsed from the product information may be associated with attribute types (in general) and subtypes (more specifically). Attribute types and subtypes may include, for example, brand, size, color, and other features related to a particular product.

Further, the preprocessor may include a rules engine for identifying relationships between products and attributes, cleaning product information, and standardizing product information. During data cleaning the product information is parsed into tokens that will be the basis for the attributes associated with a product. Rules for cleaning product information may be defined such as, for example, rules that correct errors in the parsed product information. Standardization rules may include rules that normalize variations of product information (e.g., normalizing “1½ inch,” “1½ inch,” “1½ inch” as “1½ inch”). Note that standardization and normalization of product information is different than establishing a relationship between synonymous product attributes such as, for example, “image stabilization” and “vibration reduction” in cameras.

The preprocessor 28 may parse product attributes directly from the product name and characteristics (“literal attributes”), or the rules engine of the preprocessor may derive attributes about the product (“derived attributes”) based on the literal attributes. Literal attributes may be parsed directly from the product name itself. For example, “Speed Stick: Antiperspirant Solid (Unscented)” may be parsed into four literal product attributes: “Speed Stick” (brand); “Antiperspirant” (feature); “Solid” (form); “Unscented” (scent). Each of these example attributes literally appear in the example product name and product characteristics. Derived attributes may be determined based on the literal attributes parsed from the product name and product characteristics. For example, the rules engine of the preprocessor 28 may be configured to associate attributes with the product that are semantically similar to (or synonymous with) literal attributes. For example, deodorant products having a “Solid” form may also be semantically similar to (or synonymous with) attributes such as, for example, “Regular Solid,” “Smart Solid,” or “Super Solid.” Accordingly, when constructing the list of product attributes, the preprocessor 28 may include attributes both literally included in the product name (e.g., “Solid”) and attributes semantically related to or synonymous with literal attributes of the product (e.g., “Regular Solid,” “Smart Solid,” etc.).

As another example with reference to diapers, “Easy-Ups” and “Pull-Ups” may each be semantically related to or synonymous with “Training Pants.” Therefore, the preprocessor 28 may generate the following attribute list for products literally containing either “Easy-Ups” or “Pull-Ups:” {Easy-Ups, Pull-Ups, Training Pants}. This literal and semantic approach may enable the in-product navigation system 10 and method 44 to provide broader search results as compared to an approach that only uses attributes literally included in the product name.

Moreover, the rules engine of the preprocessor 28 may use inferential rules to infer product attributes associated with a product based on the literal attributes of a the product. For example, the presence of butane or propane in the ingredients of a deodorant product identifies the deodorant as an aerosol-type deodorant. Therefore, if the product name or description does not literally include “aerosol,” the rules engine may identify “aerosol” as a product attribute, which may be inferred from the presence of butane or propane.

Once the preprocessor 28 has generated the product attribute lists, the preprocessor may transmit the product information (e.g., product names, descriptions, and attributes) to the database server 26 for storage (step 74). The preprocessor 28 may be selectively configured to transmit the product information for all products in a single storage request once parsing is complete. Additionally or alternatively, the preprocessor 28 may be selectively configured to transmit a storage request for each successfully parsed product. The preprocessor 28 may be selectively configured to employ other approaches as well.

As mentioned above, the database server 26 may include one or more databases having one or more tables for storing the product information 38. For example, the database server 26 may include a database having, for example, a product table, an attribute table, and a product/attribute relationship table. The product table may include columns for storing product information such as, for example, a unique identifier, a product name, a product description, a price, and other information related to the product. The attribute table may include columns for storing attribute information such as, for example, a unique identifier, an attribute value, an attribute type, an attribute subtype, an attribute source, and an attribute description. The attribute value column may correspond to the words and phrases parsed from the product name and product characteristics or product attributes derived during the preprocessing process 66. The attribute source column may be used to indicate whether the attribute is a literal attribute or a derived attribute. The attribute description column may be used to store explanatory information describing the attribute.

The product/attribute relationship table may include a product identifier column and an attribute identifier column. Accordingly, the unique identifiers of a product and an associated attribute may be stored in a row of the product/attribute relationship table in order to establish a relationship between a product and an attribute. The product/attribute relationship column may also include information related to the relationship between the product and the attribute. For example, the product/attribute relationship table may include a sequence identifier for indicating the position of the attribute in the product name or description. A sequence number may be used to identify the desired position of the product attribute in the product identifier. Using the example above, the attributes may be associated with the following sequence numbers: (1) “Speed Stick;” (2) “Antiperspirant;” (3) “Solid;” (4) “Unscented.” Other types of sequence identifiers may be additionally or alternatively employed to arrange the product attributes in the produce identifier such as, for example, an attribute type whereby the product attributes are arranged in the product identifier based on their associated type or subtype. With this approach, the in-product application 36 may be configured to arrange the attributes according to their associated sequence numbers when constructing a product identifier having a selectable product name and selectable product characteristics. After the databases of the database server 26 have been populated, the stored product and attribute information 38 is available to the in-product application 36 when responding to client requests.

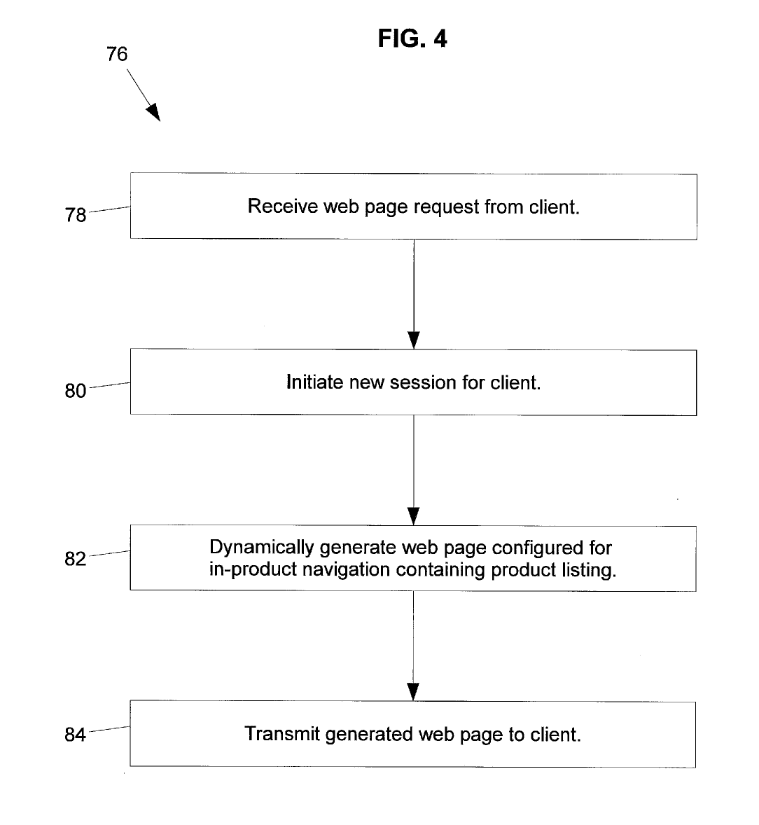

Referring now to FIG. 4, a flowchart of an example of an implementation of a client request processing process 76 of an in-product navigation method 44 is shown. The request processing process 76 starts when the in-product navigation server 12 receives a request 18 (e.g., an HTTP request) for a web page from the client (step 78). The web server 22 of the in-product server 12 receives the request 18 and initiates a session 86 (FIG. 1) with the client 14 (step 80). The session 86 may store information related to the communications exchanged between the client 14 and the in-product navigation server 12. For example, the session 86 may store and maintain a product listing 88 that corresponds to the product listing 34 displayed on the web page 32 at the client 14. The product listing 88 stored in the session 86 for the client 14 may represent the current state of the product listing 34 displayed at the client (i.e., whether the product listing has been narrowed as a result of selected filters). A new session 86 may be initiated for each client 14 that transmits a web page request 18 to the in-product navigation server 12, thus allowing the in-product navigation server 12 to maintain respective product listings 88 in respective sessions 86 for each client 14. In response to receipt of a web page request 18, the in-product application 36 may dynamically generate the requested web page 32 (step 82) and transmit the generated web page to the client 14 (step 84) in a response 20 (e.g., an HTTP response).

Referring now to FIG. 5, a flowchart of an example of an implementation of a web page construction process 88 of an in-product navigation method is shown. As mentioned above, the web server 22 of the in-product navigation server 12 receives a request 18 for a web page 32 from the client 14 (step 90). Also mentioned in the example above, a session 86 is initiated for the client 14 (step 92), and the in-product application 36 dynamically generates the requested web page as described below by way of example. The in-product application 36 may retrieve the stored product information 38 (i.e., product names, descriptions, and attributes) from the database server 26 (step 94). The database server 26 may supply the product information 38 to the in-product application 36 as a result set. This result set may be stored and maintained at the session 86 as mentioned above.

The in-product application 36 may use the product information 38 received from the database server 26 to dynamically construct the selectable product names and descriptions from the parsed attributes (step 96). The in-product application 36 may encode and format the attributes as selectable elements (FIG. 8) when constructing the product names and descriptions from the parsed attributes. The selectable product names and descriptions are then used when creating the product listing for the requested web page 32. The construction and encoding of the selectable product names and descriptions will be discussed in more detail below with reference to FIG. 6.

The in-product application 36 may then dynamically build the requested web page (step 98) inserting the selectable product names in the product listing of the web page under construction. The in-product application 36 may also include various scripts 40 (FIG. 1) or references to scripts with the web page under construction, which facilitate filtering the product list 34 of the web page 32 at the client 14. The scripts 40 may be implemented as client-side scripts configured for execution at the client. The scripts 40 may be implemented using, for example, JavaScript or other suitable client-side scripting language. The scripts 40 may be selectively embedded into the web page itself or transmitted separately to the client with references to the scripts embedded in the web page. The client-side scripts 40 will be discussed in further detail below with reference to FIG. 7.

The in-product application 36 may use dynamic web page technology such as, for example, ASP, PHP, or JSP to construct the requested web page 32. Accordingly, the in-product application 36 may use an interpreter (not shown) to process a web page template when constructing the web page transmitted to the client 14. The web page template may include structural information related to the architecture of the web page as well as instructions used to guide the construction of the web page. The interpreter may be configured to execute the instructions included in the web page template during construction of the web page. The instructions may include instructions for encoding, formatting, and arranging the selectable attributes for the products of the product listing. The instructions may also include additional instructions related to the construction or formatting of the web page.

As mentioned above, the session 86 may maintain a product listing 88 that corresponds to the product listing 34 at the client. The in-product application 36 may request and receive product information 38 from the database server 26 in, for example, a result set. The in-product application 36 may store the product result set in the web server session 86 created for the client 14 (step 100). The corresponding product listing 88 stored at the session 86 is discussed further below with reference to FIG. 7. The in-product application 36 may also be configured to update and modify the product listing 88 stored in the session 86 in response to filter requests 18 received from the client 14. Once the in-product application 36 has generated the web page 32, the web server 22 may transmit the generated web page to the client (step 102) in a response 20.

Referring now to FIG. 6, a flowchart of an example of an implementation of an attribute encoding process for product names and descriptions 104 of an in-product navigation method 44. The process 104 starts after the in-product application 36 has received the product information 38 from the database server 26 (step 106). The in-product application 36 then iterates through the product information (step 108) to construct a product identifier (FIG. 8) using the respective attributes associated with the products (step 110). As mentioned above, attributes for a product may be associated with sequence numbers. Accordingly, the in-product application 36 may construct the product identifier in accordance with the sequence numbers, which identify the position of the product attribute in the product identifier. In this example, the in-product application 36 formats the attributes as HTTP links. The in-product application 36, in this example, formats the attributes as selectable elements by encoding the attributes with the HTTP anchor tag (i.e., <a></a>).

In this example, the in-product application 36 inserts data and script calls within the anchor tag to facilitate the generation of filter requests 18 at the client 14. As shown below, the selectable portions of the product identifier correspond to the product attributes for the product. For example, the in-product application 36 may generate the following anchor tags for the product identifier of a “Speed Stick: Antiperspirant Solid (Unscented)” deodorant product:

<a href=“#” id=“pnAttr” onclick=“return OnAttrSelect(this,event,‘148150
~5~151835’);” onmouseout=“MO( );” onmouseover=“AtHover(148150,
this);” >Speed Stick</a>
<a href=“#” id=“pnAttr” onclick=“return OnAttrSelect(this,event,‘148224
~0~150626’);” onmouseout=“MO( );” onmouseover=“AtHover(148224,
this);” >Antiperspirant</a>
<a href=“#” id=“pnAttr” onclick=“return OnAttrSelect(this,event,‘145914
~5~154744’);” onmouseout=“MO( );” onmouseover=“AtHover(145914,
this);” >Solid</a>
<a href=“#” id=“pnAttr” onclick=“return OnAttrSelect(this,event,‘148177
~5~155960’);” onmouseout=“MO( );” onmouseover=“AtHover(148177,
this);” >Unscented</a>

As seen in this example, the in-product application 36 has inserted in the anchor tags a call to a filtering script (“OnAttrSelect”) that is executed when a user at the client 14 selects the attribute. Further, as seen in the example shown, the parameters for the call to the filtering script include a tilde-delimited string (e.g., “148150˜5˜151835”). This delimited string is used in this example to identify the attribute value, attribute type, and attribute subtype. In this example, the attribute value (“Speed Stick”) is identified by the unique number, “148150;” the attribute type (e.g., name) is identified by the unique number, “5;” and the attribute subtype (e.g., brand name) is identified by the unique number, “151835.” Additional or alternative approaches may be selectively employed to encode and format the attributes as selectable elements configured to generate filter requests 18 at the client 14.

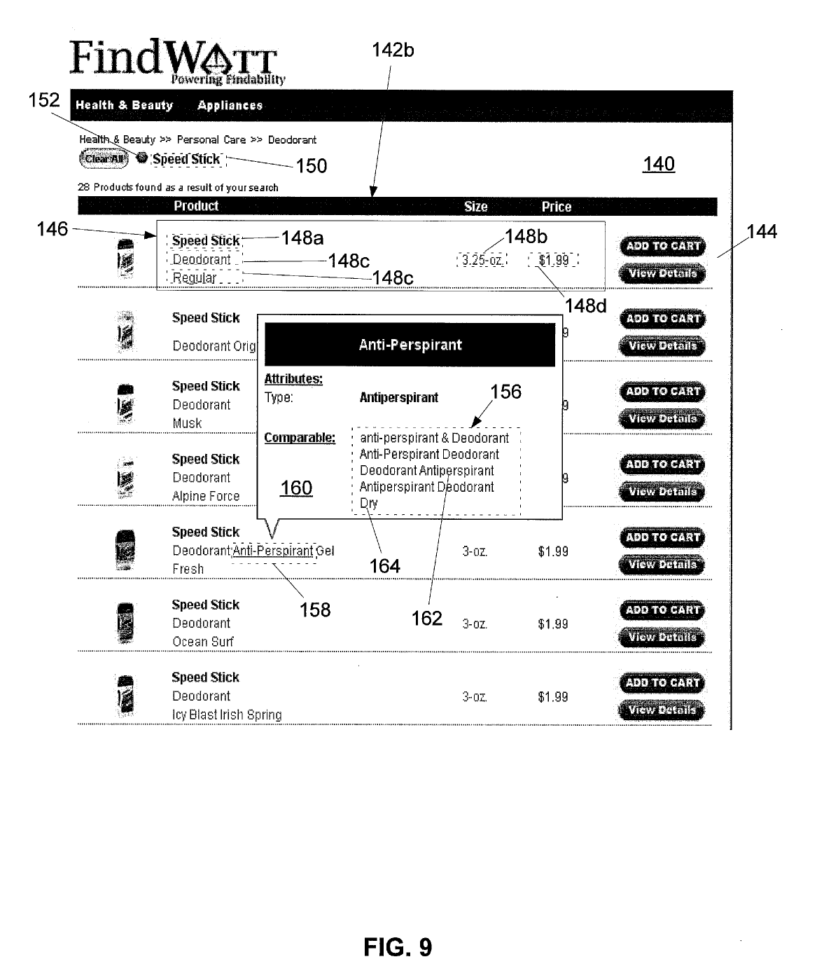

As also seen in this example, the anchor tag includes a call to a script (“AtHover”) that executes when a user hovers over the selectable element in the product listing 34 displayed on the web page 32 at the client 14. The hover script may be used to display supplemental information related to the selectable element. For example, the supplemental information may be a description of the attribute or a list of other synonymous attributes. The display of supplemental information will be discussed further below with reference to FIG. 9.

The in-product application 36 may create an anchor tag for each selectable product attribute in the product identifier. Further, the in-product application 36 may generate a selectable product identifier for each product that is included in the product list 34 of the web page 32. The in-product application 36 inserts the selectable product names and descriptions in the web page 32 under construction (step 112). Additionally, when inserting the selectable product attributes in the web page under construction, the in-product application 36 may arrange the selectable product attributes in the product identifier according to the sequence numbers respectively associated with the product attributes.

Referring now to FIG. 7, a flowchart of an example of an implementation of a filtering process 114 of an in-product navigation method 44 is shown. The process 114, in the example shown, starts once a client 14 has requested and received a web page 32 from the in-product navigation server 12 (step 116). A user at the client 14 may select one of the selectable attributes (step 118) in the product name or description to filter the product list 34 based on the selected attribute. In response to the selection of a selectable attribute, a client-side script 40 may generate a filter request 18 containing the selected attribute and transmit the filter request to the in-product navigation server 12 (step 120).

The client-side scripts 40 are used to facilitate the filtering of the product listing 34 and may be configured to make asynchronous requests to the in-product navigation server 12. Asynchronous requests refer to background requests generated after a web page 32 has been received and displayed at the client 14, which do not require reloading the entire web page. In this way, information displayed on the web page 32 may be updated without having to re-request and reload the web page. Responses 20 to asynchronous requests 18 may also be received in the background, and the information included in the responses may be used to update the information displayed on the web page 32 without re-requesting, reloading, or refreshing the entire web page. As a result, the client-side scripts 40 in this example may submit asynchronous background requests 18 to the in-product navigation server 12 when a user selects an attribute in a product name or description to filter the product listing 34.

A client-side script 40 may submit an asynchronous background request 18 (e.g., an XMLHttpRequest) to the in-product navigation server 12 (step 120) that contains the selected attribute. The asynchronous background request 18 containing the selected attribute may be referred to as a filter request. The web server 22 at the in-product navigation server 12 receives the filter request 18 (step 122), and the in-product application 36 filters the product listing based on the selected attribute (step 124). As mentioned above, the selectable attributes may be identified by unique identifiers (e.g., unique numbers) in a delimited string. These unique identifiers may be included in the filter request to identify the selected attribute or attribute type/subtype and to facilitate filtering by the in-product application 36 at the application server 24. The in-product application 36 may parse the delimited string to extract the unique identifiers for the attribute value, attribute type, and attribute subtype. The in-product application 36 may then use the attribute value, attribute type, and attribute subtype to filter the list of products to include attributes matching the attribute value, attribute type, or attribute subtype.

In the example shown, the unique numbers of the attribute identifiers respectively correspond to a set of resource files, for example, a set of XML resource files, which may also be identified by the unique numbers of the attributes. The XML filename may be the unique number of the corresponding attribute. Using the example above, the unique numbers for the attribute value (“148150”), attribute type (“5”), and attribute sub-type (“151835”) may respectively correspond to XML files named “148150.xml,” “5.xml,” and “151835.xml.” The XML files may be used to encode and store information and data related to the attribute value or attribute type/subtype. By pairing the unique identifier with the name of the XML file, the in-product application 36 has easy access to the information related to the attribute value or attribute type/subtype. The XML files may also store supplemental information related to the attribute such as a description of the attribute value or a list of semantically similar or synonymous attribute values. The XML resource files may be stored in a storage device of the application server (not shown) that is accessible by the in-product application. Other approaches may be selectively employed for storing supplemental information related to the attributes such as, for example, storing the supplemental information in one or more databases of the database server 26.

In this example, the in-product application 36 is configured to update the product result set 88 stored in the web server session 86 for the client. The in-product application 36 modifies (filters) the product result set 88 based on the selected attribute in the filter request 18. When updating the product result set 88, the in-product application 36 may constrain (i.e., limit) the result set or expand the result set by selectively applying or removing the selected attribute. The filter request 18 may indicate whether the in product application 36 should apply the selected attribute to constrain the result set or remove the selected attribute to expand the result set. If the in-product application 36 applies a filter (step 126), the in-product application may constrain (limit) the product result set 88 to those products that have the selected attribute or synonymous attributes (step 128). If the in-product application 36 removes a filter (step 130), the in-product application may expand the product result set 88 by including products that do not have the selected attribute back into the result set (step 132). Expanding the result set may involve querying the database server 26 for additional or supplemental product information 38 to refresh the product result set 88 stored in the web server session 86 (step 134).

As mentioned above, the attributes of a product may include attributes literally part of the product name or description as well as derived attributes semantically related to or synonymous with the literal attributes of the product. Accordingly, the in-product application 36 may be configured to filter the product result set 88 using both the literal attributes and the derived attributes of the product. For example, if the selected attribute for a diaper product is “Easy Ups,” the in-product application 36 may update the product result set 88 to also include products having the “Easy Ups” attribute as well as products that have the attributes semantically related to “Easy Ups” (e.g., “Pull Ups” and “Training Pants”).

The in-product application 36 may then store the updated product result set 88 in the web server session 86 for the client 14 (step 136). The web server 22 may then prepare a response 20 (e.g., an HTTP response) containing the updated product result set 88 and transmit the response containing the updated result set to the client 14 (step 138). The client 14 receives the response 20 containing the updated product result set 88 and refreshes the product listing 34 of the web page 32 with the updated product result set. A user at the client 14 may select additional attributes to further filter the product listing 34 with subsequent filter requests. Additionally, the client 14 may also remove selected attributes to expand the product listing 34 in subsequent filter requests.

The asynchronous background requests 20 may be implemented using an AJAX platform (asynchronous JavaScript and XML). Further, Anthem.NET is a development tool that may be used to implement the asynchronous updates to the product listing 34 on the web page 32. More information regarding Anthem.NET may be found at:

http://anthem-dot-net.sourceforge.net/ and

http://sourceforge.net/projects/anthem-dot-net/

Referring now to FIG. 8, a portion of an example web page 140 configured for in-product navigation is shown. As seen in FIG. 8, the example web page 140 includes a product listing 142a having individual rows 144 of consumer products, deodorant products in this example. The individual rows 144 of products include the product identifier 146 comprised of product attributes 148a-d, which are formatted as selectable attributes related to the product. The deodorant products in the example shown include the name/brand of the product 148a, the size of the product 148b, one or more characteristics 148c (i.e., a description) of the product, and a product price 148d. As seen in FIG. 8, each one of these attributes 148a-d is a selectable element presented directly in the product identifier 146 in each row 144 of the list of products 142a. A user may select these selectable attributes 148a-d to filter the product listing 142a.

For example, FIG. 9 shows the example web page 140 of FIG. 8 when the “Speed Stick” attribute 150 is selected and applied as a filter to the product listing 142b. As seen in FIG. 9, the selected attribute 150 is displayed above the product listing 142b. Further, the product listing 142b in the example shown only includes deodorant products that have the “Speed Stick” attribute 150. The web page 140 may also include a button 152 for removing the selected attribute 150. In the example shown in FIG. 9, removing the selected attribute 150 (“Speed Stick”) would refresh the product listing 142b to the list of products 142a shown be way of example in FIG. 8.

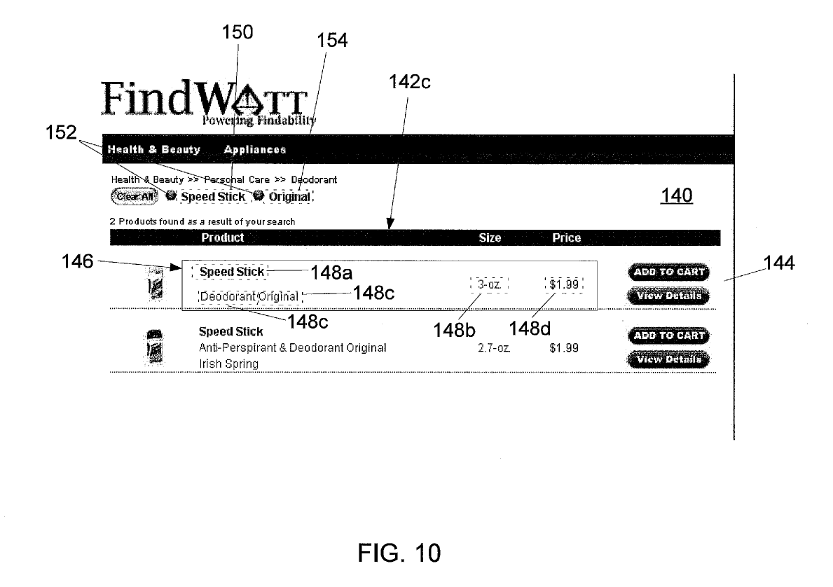

FIG. 10 shows the example web page 140 of FIG. 9 when a second attribute 154 has been selected to filter the product listing 142c. In FIG. 10, the “Original” attribute 154 has been added to the list of selected attributes. Accordingly, the product listing 142c in FIG. 10 only includes those deodorant products that have the “Speed Stick” attribute 150 and the “Original” attribute 154. If a user removes the “Original” attribute 154 from the list of selected attributes, the example product listing 142c will return to the product listing 142b shown in FIG. 9 in which only “Speed Stick” products are shown. If the user removes both the “Original” attribute 154 and the “Speed Stick” attribute 150, the example product listing 142c will return to the original product listing 142a shown in FIG. 8.

Referring back to FIG. 9, another aspect of in-product navigation is shown. In-product navigation may also be configured to provide supplemental information 156 about a selectable attribute 158 in a pop-up component 160. The pop-up component 160 may be displayed when a user hovers over a selectable attribute 158 as discussed above. As seen in FIG. 9, the “Anti-Perspirant” attribute 158 is hovered over and a pop-up component 160 is displayed in response. The pop-up component 160 may provide supplemental information 156 about the selectable attribute (e.g., a definition of the attribute or a list of synonymous or semantically similar attributes). As seen in FIG. 9, for example, the “Anti-Perspirant” attribute 158 is synonymous with “Antiperspirant” 162, “Dry” 164, and other similar attributes. In this way, the in-product navigation system 10 is configured to provide users with more information related to the meaning of or alternatives to the selectable attribute. As a result, users may be more informed when selecting attributes in order to filter the product list and locate a desired product.

The supplemental information 156 may be requested and retrieved from the in-product navigation server 12 using the “AtHover” script 40 in conjunction with an asynchronous request 18 and associated XML file as described above. Additionally or alternatively, the supplemental information 156 may be included with the dynamically generated web page 32 or stored in the database server 26 and retrieved by the in-product application 36 in response to receipt of an asynchronous request 18. Other approaches may be selectively employed for requesting and transmitting supplemental information 156 for display at the web page 18.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain details described herein can be varied considerably without departing from the basic principles of the invention.

What is claimed is:

1. A computer-implemented method for updating a product list of one or more products displayed on a web page comprising:
receiving a request to update the product list, the request containing an update criterion wherein the update criterion is associated with a selectable portion of a product identifier that is displayed in the product list of the web page;
updating a product list that corresponds to the product list of the web page based on the update criterion; and
transmitting the updated product list in a response such that the updated product list replaces the product list of the web page.

2. The computer-implemented method of claim 1 wherein the selectable portion of the product identifier is a product name or a product characteristic.

3. The computer-implemented method of claim 2 wherein updating the product list that corresponds to the product list of the web page includes limiting the updated product list to include only products having a product name or a product characteristic that matches the selectable portion of the product identifier associated with the update criterion.

4. The computer-implemented method of claim 3 wherein updating the product list that corresponds to the product list of the web page includes limiting the updated product list to also include products having a product name or a product characteristic synonymous with the selectable portion of the product identifier associated with the update criterion.

5. The computer-implemented method of claim 4 wherein the request is an asynchronous request and the response is an asynchronous response.

6. A computer-implemented method of configuring a web page to display a product list comprising:
receiving one or more product attributes associated with a product;
encoding a product attribute of the received product attributes as a selectable portion of a product identifier for the product; and
including the selectable portion of the product identifier that corresponds to the encoded product attribute in a product list of the web page such that the product attribute is selectable from the product list when the product list is displayed on the web page.

7. The computer-implemented method of claim 6 wherein a product attribute of the received product attributes is a product name or a product characteristic.

8. The computer-implemented method of claim 7 further comprising encoding the product attribute such that a request to update the product list of the web page based on the product attribute selected is generated when the selectable portion of the product identifier that corresponds to the encoded product attribute is selected from the product list.

9. The computer-implemented method of claim 8 further comprising encoding each product attribute associated with the product as a selectable portion of the product identifier for the product such that each portion of the product identifier for the product is selectable from the product list when the product list is displayed on the web page.

10. The computer-implemented method of claim 9 wherein sequence identifiers are respectively associated with the received product attributes and further comprising arranging the selectable portions of the product identifier based on the sequence identifiers.

11. The computer-implemented method of claim 10 further comprising preprocessing a product list of one or more products having product data respectively associated with the one or more products of the product list wherein preprocessing includes:
parsing the product data associated with a product in the product list;
identifying at least one product attribute related to the product in the product list based on the parsed product data associated with the product; and
associating the identified product attribute with the product.

12. A system for updating a product list of one or more products displayed on a web page comprising:
a request processing module configured to:
receive a request to update the product list, the request containing an update criterion wherein the update criterion is associated with a selectable portion of a product identifier that is displayed in the product list of the web page;
update a product list that corresponds to the product list of the web page based on the update criterion; and
transmit the updated product list in a response such that the updated product list replaces the product list of the web page.

13. The system of claim 12 wherein the selectable portion of the product identifier is a product name or a product characteristic.

14. The system of claim 13 wherein the request processing module is further configured to limit the updated product list to include only products having a product name or a product characteristic that matches the selectable portion of the product identifier associated with the update criterion.

15. The system of claim 14 wherein the request processing module is further configured to constrain the updated product list such that products having a product name or a product characteristic synonymous with the selectable portion of the product identifier displayed in the product list of the web page are also included in the updated product list.

16. The system of claim 15 wherein the request received by the request processing module is an asynchronous request and the response transmitted by the request processing module is an asynchronous response.

17. A system for configuring a web page to display a product list comprising:
a storage module storing product information, the product information including one or more product attributes respectively associated with one or more products stored in the storage module; and
a web page generation module in signal communication with the storage module, the web page generation module configured to:
construct a web page that includes a product list that lists one or more of the products stored in the storage module;
receive from the storage module the one or more product attributes associated with a product stored in the storage module;
encode a product attribute of the received product attributes as a selectable portion of a product identifier for the product; and
include the selectable portion of the product identifier that corresponds to the encoded product attribute in the product list of the web page such that the product attribute is selectable from the product list when the product list is displayed on the web page.

18. The system of claim 17 wherein a product attribute of the received product attributes is a product name or a product characteristic.

19. The system of claim 19 wherein the web page generation module is further configured to encode the product attribute such that a request to update the product list of the web page is generated when the selectable portion of the product identifier that corresponds to the encoded product attribute is selected from the product list.

20. The system of claim 19 wherein the web page generation module is further configured to encode each product attribute associated with the product as a selectable portion of the product identifier for the product such that each portion of the product identifier for the product is selectable from the product list when the product list is displayed on the web page.

21. The system of claim 20 wherein sequence identifiers are respectively associated with the receives product attributes and wherein the web page generation module is further configured to arrange the selectable portions of the product identifier based on the sequence identifiers.

22. The system of claim 20 further comprising a preprocessor in signal communication with the storage module, the preprocessor configured to:
receive a product list of one or more products having product data respectively associated with the one or more products of the product list;
parse the product data associated with a product in the product list;
identify at least one product attribute related to the product in the product list based on the parsed product data associated with the product; and
associate the identified product attribute with the product.
